(19) United States
(12) Patent Application Publication
(10) Pub. No.: US 2005/0153023 A1
(43) Pub. Date: Jul. 14, 2005

(54) Rolling pastry cutter kit with interchangeable pastry cutting units and method of use thereof

(76) Inventor: Corey David Overton, Roswell, GA (US)

Correspondence Address: Mr. Corey D. Overton, 925 Laurel Mill Drive, Roswell, GA, 30076, US

(21) Appl. No.: 11/028,749

(22) Filed: Jan. 4, 2005

Related U.S. Application Data
(60) Provisional application No. 60/536,264, filed on Jan. 14, 2004.

(51) Int. Cl. A23G 3/00

(52) U.S. Cl. 426/94

(57) ABSTRACT

A ready-to-bake dough cutting kit includes a hand manipulated rotary cutter with replaceable and interchangeable pastry cutter units. Each cutter unit is equipped with a connector element matching complementary connector elements on the rotary cutter. Cutter units have outwardly extending blades for pressing into the dough when the rotary cutter is rolled across it. Cutter blade elements have shapes intended to evoke themes or occasions, and are provided in sets as optional patterns. Pastry cutter units with chosen patterns, placed on the rotary cutter will transfer a corresponding shape to dough sheets during the rolling, cutting process. The kit further includes pre-rolled, ready-to-bake sheets of dough from which cookies, crackers and the like may be cut and shaped by the rotary cutter. Additional smooth roller units may be included in the kit so as to be applied in re-rolling scraps resulting from the dough cutting process.

### REFERENCE TO RELATED APPLICATIONS

This application claims all priority benefits under 37 CFR 1.119 for provisional patent application No. 60/536,264 filed Jan. 14, 2004, hereby incorporated by reference in its entirety.

### STATEMENT REGARDING FEDERALLY SPONSORED RESEARCH OR DEVELOPMENT

Not applicable

### REFERENCE TO SEQUENCE LISTING

Not applicable

### BACKGROUND OF THE INVENTION

The present inventive device and method relate to the general field of pastry preparation, particularly where dough is prepared in advance of forming shaped morsels or edible snacks for baking. More specifically, the invention relates to implements and methods for forming the snacks referred to herein, as examples, only as cookies or crackers. For example, the present invention is especially useful in the preparation of cookies and other dough-based food products to be shaped or molded into decorative, thematic or otherwise symbolic and entertaining configurations as might be desired for special occasions. Of course, the present device and method could be used anytime shaped, edible snacks are desired.

For many years, perhaps even centuries, people have been preparing dough or dough-like substances to produce baked, edible food items. For today's busy people, this effort is often unwelcome. For example, the steps of acquiring proper mixing ingredients, stirring, manipulating and rolling-out the dough, shaping or otherwise separating pieces to be baked into cookie or cracker form takes time. For many people, the tedious steps of shaping, as by the use of manually operated cookie cutters, are simply out of the question. This is particularly true where shaping steps are carried out one-by-one in series. Hence, the development of methods and devices for facilitating the snack preparation process are forever ongoing goals.

As a consequence of industrial innovation, most people can, and do, avoid the preparation phase and baking time altogether, purchasing ready-to-eat foods of all kinds. These may even be snacks in the form of cookies, crackers and the like which are pre-baked in specific shapes reflecting certain holidays or other occasions and themes. More recently, desiring at least a modicum of wholesome freshness, many consumers are turning to the “ready-to-bake” innovations of the more recent past.

Though ready-to-bake pastry dough is in many respects more convenient, particularly in terms of delivering a reasonably quick, freshly baked snack, such products do not lend themselves to shaping or decoration by the consumer. Beyond that, they offer little or no entertainment or educational value in terms of a playful snack preparation process.

For example, the patent issued to Blaschke et al. and designated as U.S. Pat. No. 6,280,783 shows a dough product that is prepared in block or sheet form and produced as “ready to use.” Score lines on the dough product are placed in position to indicate where pieces may be broken off for subsequent baking. U.S. Pat. No. 6,413,563 granted to Blaschke et al. shows another “break-and-bake” form of cookie dough product with a grooved surface to define portions to be removed for baking. Shaping of the snack, if any, is limited to the crudely broken edges at factory-determined grooves.

Only slightly more interesting, perhaps, are the products from the inventive ovens of Gavie et al. and Kuechle et al. described as follows. The patent issued to Gavie et al., and designated as U.S. Pat. No. 6,627,239 teaches the use of dough sheets with break-off portions where the portions are pre-formed with decorative designs. Another commonly known “ready-for-use” pastry product is “scoopable” dough, described in U.S. Pat. No. 6,436,458 granted to Kuechle et al., This dough product is similarly broken or scooped in factory-driven portions and onto cookware for baking into a ubiquitous shape.

These and similar innovations which have emerged to lessen the baking consumer's burden are based on the concept of the dough “melting,” as it is heated, into a generic cookie shape. Custom shaping or decorating of such “melt-able” dough is not possible. Typically, dough of the type described cannot be conveniently shaped to a customized or “fun” shape in their cold state.

Attempting to shape dough segments or pieces during the heating process is neither safe nor convenient; and post-bake shaping is generally hopeless. Even when allowed to cool to a workable state, a pastry cutter will tend to produce an undesirable pinching effect at the cookie or cracker edges. When fully cooled, the cookie or cracker is usually too brittle for aesthetic cutting or shaping.

Still, the vast majority of cookie consumption involves the popular factory-made, store-bought variety. Lost in the quest for quick-snack convenience are the entertainment, creativity, and familial interactions to be enjoyed from custom-cutting and baking cookies at home. Also lost are the opportunities for shaping motor skills and artistic expression, to say nothing about the value of the learning from the hands-on experience and the kitchen-centric family interaction.

For those wishing to employ cutters for shaping dough elements from a sheet of pre-rolled dough, a variety of cutting implements are available. These most typically include individual cutting forms or patterns known generally as cookie-cutters, many with gripping handles, for pressing a cutting edge into a relatively thin layer of dough. These cutting forms sometimes are available in a kit or discrete collection including a variety of pattern shapes.

Typically, dough is placed on a cutting board, dusted with flour to avoid tackiness or stickiness, and then rolled or flattened by a cylindrical rolling pin with an axially extending handle at each end. In a separate step, and with the use of one or more hand-wielded cutting forms, shaped dough pieces are defined in the flattened dough. The shaped dough pieces or morsels are then carefully removed one by one and placed on cookware for subsequent baking. This is a tedious process that could become more entertaining with the application of an appropriate set of implements as envisioned with the present invention to be described.

For centuries, a dough processing tool known as a springerle has been utilized to form and cut the dough of cookies, crackers and the like. The springerle is widely known as having a wooden, cylindrical dough-working implement with embossed designs or mold patterns arranged around its periphery. Similar to the well-known, smooth-surfaced rolling pin, the cylindrical springerle usually includes a pair of axial handles for ease of manipulation.

The hand tool known as the springerle is not inexpensive; nor does it enjoy removable and/or interchangeable mold patterns. To provide alternate mold patterns would require the acquisition of additional springerles. Also the springerle and the other above noted implements stand alone (i.e., they are independent elements or implements) and are not combined in a convenient kit.

On some festive occasions, consumers seek cookies with hand-painted designs, normally applied after the baking process. Cooper, in published U.S. Patent Application No. 20030003204 refers to the popular use of edible paints for decorating cookies, in addition to the traditional icings and sprinkles. Edible paint may be made, for example, by mixing food coloring with powdered milk or egg yolks. Further, Cooper describes a cookie cutting and printing implement which includes a flat base with a first side and second side.

Cooper's shaping/cutting element is placed on the first side of the flat base to serve as a cookie shaping tool. On the second side of the flat base, a printing element is adapted to apply edible paint to the baked cookie. Thus, this single tool serves to both cut and decorate the cookie, but cannot produce batches are a relatively swift rate.

In U.S. Pat. No. 5,162,119, Pappas et al., show a factory-based cookie or cracker production system. The system is described as including combined apparatus for decorating and cutting cookies as they are fed through the manufacturing process. Illustrated by Pappas et al. in FIGS. 16, 21-25, and (in more detail) FIGS. 26-29 is the teaching of a cylindrical processing drum 202 having mounted thereon (and affixed thereto) a plurality of individual cutters 308 arranged around the periphery of the drum 202.

Papas et al. further indicate that these cutters 308 may be round in shape for cutting round crackers or cookies, and thus are placed in circumferential rings and transverse rows on the drum 202. Cutters 308 are shown with cutting edges 314 extending from base portion 312, which further is provided with a cavity 316 communicating with air supply holes 318 (for pressurizing the cavity 316 to facilitate release of the formed cookie or cracker product).

While cutters 308 may be removed and replaced or interchanged for different shapes, shutdown of the operation is required, along with an obviously tedious removal of fastening elements securing the cutters 308 to drum 202. Although, for extended factory runs, this arrangement probably works satisfactorily in a factory setting, it is not applicable in a typical home kitchen where a simple kit would be far more appropriate.

An example of a kit is shown in U.S. Pat. No. 5,213,371. Patentee Bradley discloses a cookie cutter kit involving a greeting card with a manual cutter combined with dry cookie mix. This kit, of course, includes only one cutter and enough mix to prepare a very limited quantity of snack food.

Thus, a variety of alternatives has evolved reflecting a great number of efforts invested into developing efficient and/or convenient baking product innovations for cookies, crackers, and similar snack foods. Nonetheless, shortcomings still exist. Most notably, there exists no convenient kit of interchangeable cutting patterns or molds on a manually operable, rolling cutter implement.

When combined with an appropriately formed sheet of pre-rolled dough, the multi-mold rolling cutter to be described below presents a unique device and method that brings back the enjoyment of custom-decorative cookie baking. The present inventive device and its method of use effectively resolve these and other shortcomings existing in the art.

### BRIEF SUMMARY OF THE INVENTION

An object of the invention described below is to provide a new and improved method and device for preparing pastry dough for baking, and to make the device and method conveniently available in the form of a kit for shaping and cutting the dough. A further object is to provide a unique kit and its method of application to enable users to apply at least one decorative shape to pre-rolled cookie dough, pastry and the like.

Another objective is to provide a kit and its method of use including a substantially cylindrical rotary cutter implement easily manipulated through use of at least one handle. Such a kit would present a set of alternative pastry shaping and/or cutter units to be applied through rotary cutter pressure to one or more portions of a pre-rolled, ready-to-bake sheet of dough. Another objective is to present a pastry dough shaping or cutting tool in the form of a rotary cutter implement to which pastry cutter units are readily applied, removed, and exchanged so as to impart a selected variety of patterns in shaping cut dough.

Another objective of the present inventive method and device is to provide a unique interconnection between the pastry cutter units and the rotary cutter implement, whereby the pastry cutter units may be quickly added, removed, and interchanged, and may be selectively positioned on an outer surface of the rotary cutter implement in a variety of positions as a matter of choice on the part of the user.

Further, it is an objective to present a kit and method, in accordance with the present invention, with one or more pre-rolled pastry dough sheets. Such sheet or sheets may be stored within said kit in a flat layer or layers, or rolled-up in a “jelly-roll” configuration so as to be conveniently processed by the unique rotary cutter and the pastry cutter units mounted thereon.

Finally, it is an objective to provide a kit and its method of use, in accordance with the present invention, wherein a set of smooth surfaced pastry roller units are presented for optional, temporary placement on an outer surface of the rotary pastry cutter (in place of the pastry cutter units) so as to re-roll scrap dough pieces or remnants resulting from the cutting and shaping of dough portions for recycling.

Still other objects, features, and characteristics of the present invention will become apparent upon consideration of the following full description, and with reference to the accompanying drawings, wherein like reference numerals or characters indicate corresponding elements in the various figures.

### BRIEF DESCRIPTION OF THE SEVERAL VIEWS OF THE DRAWINGS

Referring now to the accompanying drawings, constituting a part hereof, it is seen that:

FIG. 1 is a perspective, exploded view of the rotary cutter implement showing its various components;

FIG. 2 is a perspective view of the rotary cutter in fully assembled mode;

FIG. 3 is an end view of a curled-up or rolled sheet of pre-rolled, ready-to-bake pastry dough suitably supplied as part of the inventive kit and method;

FIG. 4 is an edge view of multi-layered, pre-rolled, ready-to-bake pastry dough consisting of one or more (as shown) flat sheets optionally supplied as part of the inventive kit and method.

FIG. 5 illustrates a perspective view of the rotary cutter implement with cutter units removed and replaced by smooth, roller units.

### DETAILED DESCRIPTION OF THE INVENTION

With reference to FIG. 1, the inventive device and method are illustrated in an exploded perspective view, wherein a first pastry cutter unit 1 is shown in place and secured to rotary cutter implement 2. The rotary cutter 2 is substantially cylindrical in form and with a central axis. Additional pastry cutter units 1, substantially identical to and interchangeable with said first pastry cutter unit, are illustrated in this exploded view as withdrawn from, or ready to be assembled on, said rotary cutter 2.

These pastry cutter units 1 are formed such that they are generally identical to one another and mutually interchangeable on said cylindrical rotary cutter. Further, each said pastry cutter unit 1 includes a first side or outer surface adapted to carry a cutter blade element 1c formed in the shape of a decorative pattern (shown here, by way of example only, as a holiday tree). Cutter blade element 1c extends slightly outwardly from said outer surface. Each said pastry cutter unit 1 further includes a second side or inner surface adapted to carry or incorporate a connecting element or tongue member 1a as will be described further herebelow.

A total of four (4) cutter units are illustrated, by way of example only and not to be considered in any way as limiting the scope of the present invention. End cap 4 is provided for ensuring that the pastry cutter units remain in place when assembled onto the rotary cutter 2 as will be described below. Cap 4 may be fastened in any of a variety of well known ways ranging from the application of a self-stick, removable adhesive to the rear side thereof, to provision of flexible clips that appropriately fasten to the end of the rotary cutter. Optionally, the cap 4 may include thin shim or wedge clip elements 4a shaped to fit between connecting elements as will be further described.

Furthermore, any of a variety of arrangements could be employed to fasten each of said pastry cutter units 1 to the rotary cutter 2. Shown in FIG. 1 is a tongue-and-slot arrangement wherein a plurality of outwardly open slots 2a is provided within rotary cutter 2. Such slots 2a are formed as complementary connecting elements associated with corresponding connecting elements or tongue members 1a extending from said second side of each of said pastry cutter units 1.

As is understood in the art of designing such implements, adequate play or clearance is afforded for the required matching movement of tongue 1a and slot 2a to permit rapid and effortless placement and removal. On the other hand, the connecting elements and complementary connecting elements must have a reasonably snug interference fit so as to remain stable during use. In any case, wedge clip elements 4a, as part of cap 4, may be slipped between the tongue and slot arrangement to tighten the interconnection fit.

A variety of equivalent attachment arrangements are envisioned as satisfying the need to affix the pastry cutter units 1 to rotary cutter 2. For example, with only slight modifications, the tongue and groove placement just described could be reversed such that the rotary cutter 2 includes tongue members while the pastry cutter unit 1 includes matching slots. It is important, however, that all the pastry cutter units 1 be interchangeable and readily removed and replaced.

When a pastry cutter unit 1 is moved into position, i.e., slid axially and along the surface of rotary cutter 2 such that tongue 1a and slot 2a are properly engaged, said unit 1 is held in close fit position by guiding elements 2b stationed at appropriate positions around the periphery of said rotary cutter. Said guiding elements 2b may be integrally formed or fixedly attached in strategic positions on the rotary cutter cylindrical periphery.

To manipulate the rotary cutter across a sheet of pre-rolled pastry dough, handle 3 is provided. Handle 3 is affixed to a first end of handle extension 5, which terminates at its second end in an axial extension (not shown) within a center opening or cavity within rotary cutter 2. This is not illustrated, but is essentially the same as a typical well-known paint roller/handle combination in wide use. In this construction, rotary cutter 2 is adapted to be freely rotated on its axis as supported upon handle extension 5, in much the same manner a paint roller is mounted on a one-handle holder. Manipulation of the handle 3 in such a way as to roll the rotary cutter 2 across a sheet of pre-rolled pastry dough thus serves to cut shapes dictated by the pattern presented by cutter elements 1c as selected for said pastry cutter unit 1.

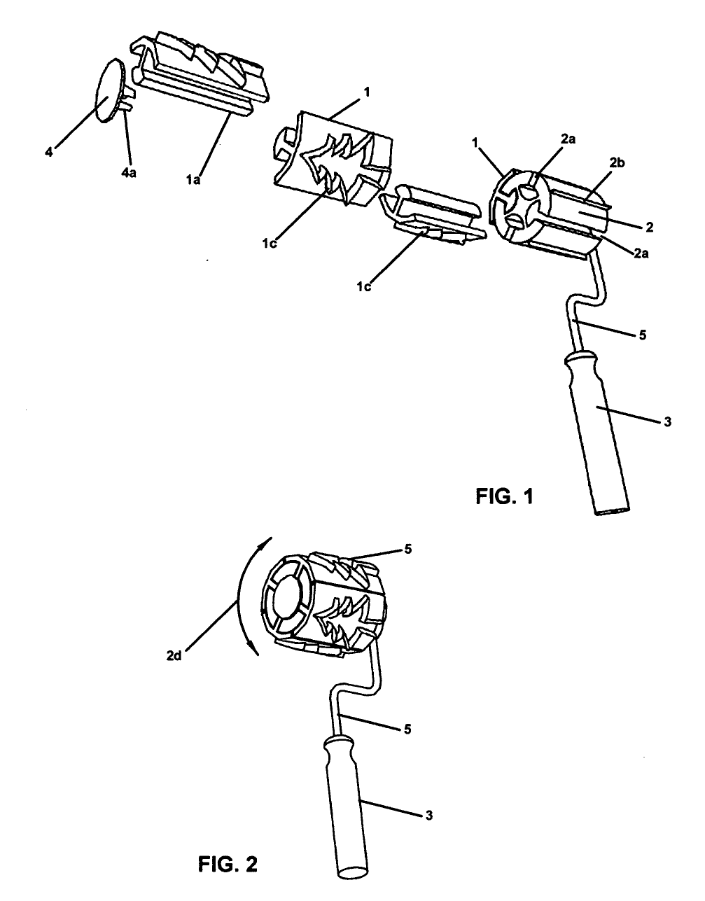

Shown in FIG. 2 is the fully assembled rotary cutter 2 with pastry units 1 in place. As indicated by the arrow 2d in FIG. 2, the rotary cutter is capable of bidirectional rolling movement so as to enable the user to re-trace or repeat cutting movements when necessary to perfect a cut pastry product. Often a rocking movement is applied to the rotary cutter 2.

Illustrated in FIG. 5 is a full set of substantially smooth pastry roller units 8, that is, “cutter units” without any cutting edges 1c, but otherwise structurally similar. These roller units 8 are to be mounted interchangeably with the bladed pastry cutter units, and are to be employed in re-rolling, or recycling, scraps of pastry dough remaining after the cut and shaped portions are removed. Once restored by pressure-rolling to a smooth, thin sheet, such recycled pastry dough may be subjected again to the action of rotary cutter 2 with bladed pastry cutter units 1.

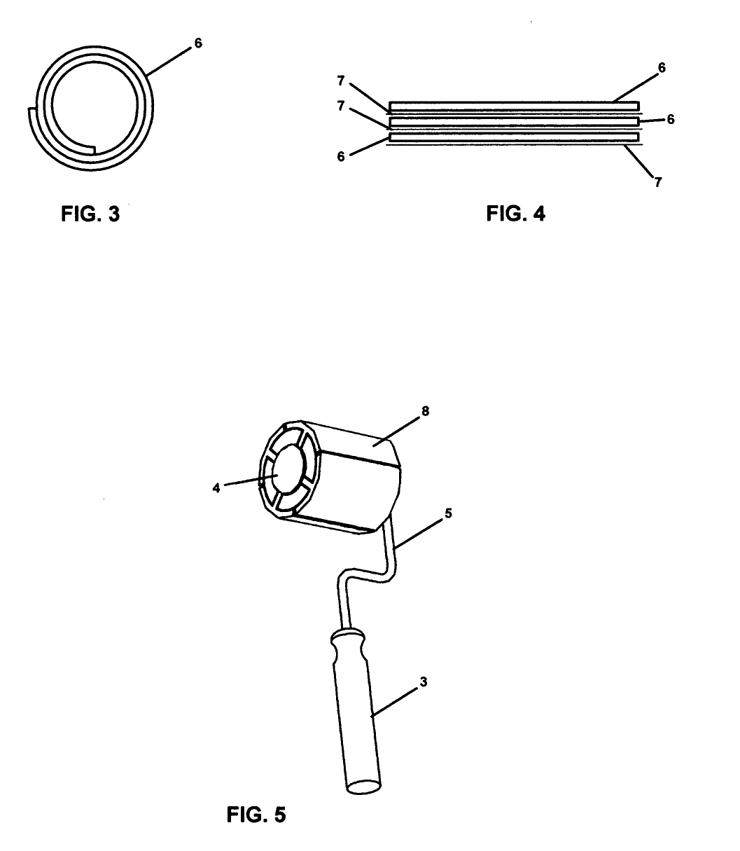

Pre-rolled pastry dough (also called ready-to-bake, ready-to-use, oven ready, and bake-ready dough) for cookies, crackers and the like may be furnished either separately or as part of a pastry preparation kit in keeping with the scope and spirit of the present inventive device and method. For example, FIG. 3 shows a pre-rolled pastry dough sheet 6 in a rolled-up or curled-up configuration (similar to a jellyroll configuration). A different pre-rolled dough configuration is presented in FIG. 4 wherein multiple sheets 6 are shown as layered with interleafing sheets of non-stick separating material 7 such as waxed paper. Non-stick material may also be included in the roll-up sheet version discussed above.

A complete kit, in keeping with the elements of the inventive device and method collectively described and illustrated herein, would thus include a set of generally identical and interchangeable pastry cutter units 1 having a number of different patterns with decorative configurations forming shaped cutter blades 1c, along with one or more substantially smooth pastry roller units. A handle of the type illustrated at 3 would be included either assembled or disassembled, depending on packaging requirements.

Further included would be a rotary cutter 2 with slots 2a and having at least one manually manipulated handle 3. Said kit may further include one or more pre-rolled, ready-to-bake pastry dough sheets 6, either flat or curled-up. Other items to be included in such a kit are decorating substances such as well-known edible paint, small candy beads, powdered sugar and the like (not shown). This kit may be packaged as a commercial unit, and may be accompanied by supplementary pastry cutter units separately packaged and sold.

The elements of the kit, such as the pastry cutter and roller units, the rotary cutter, the handle, handle extensions, cap and connectors can be formed or fabricated from any of a variety of materials depending upon the strength requirements. For example handle extension 5 would normally be fabricated from metal, given the rugged nature of its application. All parts however may be fabricated of plastic, metal, rubber or wood, or a combination of such materials. Pre-rolled, ready-to-bake pastry dough may be made from well-known recipes that deliver stable cookie or cracker shapes following the baking process.

The pastry dough preparation kit and its method of use as described herein afford users (most particularly families and close friends celebrating special holidays together) the opportunity to acquaint themselves with the joys of creative baking. A ready-to-bake, pre-rolled pastry dough sheet 6 is laid out and appropriately flour-dusted and arranged on a similarly dusted cutting board. Pastry cutter units 1 are selected (based upon their respective cutter blade element 1c configuration) from a variety of cutting shapes or forms furnished in the kit and placed upon the rotary cutter as described above. Fastener 4 is stuck, snapped, wedged, or otherwise affixed in place to keep the cutter units from sliding free during application.

By manipulating handle 3 and extension 5, the cutter units 1 (and their respective blades 1c) are pressed and rolled so as to engage with the dough sheet 6, thus cutting shaped dough pieces to be baked into holiday-theme cookies, crackers and the like. When all available pastry dough sheets are consumed, remnants or scraps left behind may be collected and placed again upon the cutting board. Blank or substantially smooth roller units 8 (i.e., “cutter” units without the cutting edges or patterns) are then placed upon the rotary cutter support (replacing any “bladed” pastry cutter units thereon) and the scraps are roller-pressed and recycled through the shape cutting process.

When finished with the dough cutting operation, all elements of the kit may be cleaned and stored for future use. Extra cutter units with uniquely different patterns or themes may be acquired separately (that is, if not part of the kit) as can additional pre-rolled ready-to-bake pastry sheets, for future baking experiences.

Upon careful review of the foregoing specification and drawings, it will be evident that the present invention is susceptible of many modifications, combinations and alterations which may differ from those specifically set forth. The particular arrangements disclosed are meant to be illustrative only and not limiting as to the scope of the invention which is to be given the full breadth of claims appended hereto and any and all equivalents thereof.

1. A pastry dough cutting device for cutting decorative shapes from a sheet of pre-rolled, ready-to-bake pastry dough so as to produce shaped cookies, crackers and the like, said device including:
a substantially cylindrical rotary cutter having a central axis and mounted for rotation about said axis;
at least one pastry cutter unit having a first and second side, and adapted to be removably mounted on said rotary cutter;
a cutter blade element fixedly mounted to said first side of said pastry cutter unit and extending outwardly therefrom;
said cutter blade element having a decorative configuration to be imparted to said dough during cutting so as to produce said decorative shapes;
said second side of said pastry cutter unit including at least one connecting element;
said cylindrical rotary cutter including at least one complementary connecting element located thereon, and adapted to cooperate with said pastry cutter unit connecting element to fasten said cutter unit on said rotary cutter;
said pastry cutter unit along with its cutter blade element with decorative configuration is selectively mounted on said cylindrical rotary cutter through cooperation of said cutter unit connecting element and said complementary connecting element;
whereby a selected cutter unit with its cutter blade element is fastened to the rotary cutter, such that rotary movement of said rotary cutter against a sheet of dough cuts shapes therefrom in a pattern imparted by said cutter blade element decorative configuration.

2. The pastry dough cutting device of claim 1 wherein said device further includes:
plural pastry cutter units adapted to be selectively mounted on and affixed to said cylindrical rotary cutter;
each of said plural pastry cutter units including a cutter blade element with a decorative configuration to be imparted to said dough during cutting so as to produce said decorative shapes;
whereby rotary movement of said rotary cutter against a sheet of dough cuts multiple pieces therefrom in pattern shapes imparted by said cutter elements.

3. The pastry dough cutting device of claim 2 wherein said pastry cutter units, cutter blade elements, and rotary cutter may be fabricated from a material selected from the group consisting of metal, plastic, rubber wood, and combinations thereof.

4. The pastry dough cutting device of claim 2 further defined as including:
said at least one complementary connecting element formed as a slot element and said connecting element formed as a tongue element;
said tongue and slot elements adapted to mutually engage so as to fasten said cutter unit on said rotary cutter.

5. The pastry dough cutting device of claim 2, further including:
said plural pastry cutter units being generally identical and mutually interchangeable on said cylindrical rotary cutter.

6. The pastry dough cutting device of claim 1, further defined as including:
at least one handle adapted to be attached to said cylindrical rotary cutter so as to be manually manipulated;
whereby manipulation of said handle causes said rotary cutter to rotate against said sheet of dough.

7. The pastry dough cutting device of claim 6 wherein said handle may be fabricated from a material selected from the group consisting of metal, plastic, wood, rubber and combinations thereof.

8. The pastry dough cutting device of claim 2, further defined as including:
sets of said plural pastry cutter units having cutter blade elements;
said blade elements have decorative configurations to be imparted to said dough during cutting so as to produce a variety of uniquely decorative shapes.

9. A pastry dough cutting kit for forming cookies, crackers and the like to be baked into decorative shapes, said kit including:
a rotary cutter, a set of pastry cutter units with cutter elements and at least one sheet of pre-rolled ready-to-bake pastry dough;
said rotary cutter further defined as substantially cylindrical in form, and with a central axis, said rotary cutter mounted for rotation about said axis;
said set of pastry cutter units each including a first and second side, and each said pastry cutter unit further adapted to be removably mounted on said rotary cutter;
said set of pastry cutter units further including a cutter blade element fixedly mounted to its said first side and extending outwardly therefrom;
each said cutter blade element further having a decorative configuration to be imparted to said sheet of pastry dough during cutting so as to produce said decorative shapes;
each of said pastry cutter unit second sides further including at least one connecting element;
said cylindrical rotary cutter including a set of complementary connecting elements located therein, each of said complementary connecting elements adapted to cooperate with said pastry cutter unit connecting elements so as to fasten said cutter units on said rotary cutter;
said pastry cutter units along with their cutter elements with decorative configurations are selectively fastened to said cylindrical rotary cutter through cooperation of said cutter unit connecting elements and said rotary cutter complementary connecting elements;
whereby selected pastry cutter units with their cutter elements element are fastened to the rotary cutter, such that rotary movement of said rotary cutter against said sheet of pastry dough cuts pieces therefrom in patterns imparted by said cutter blade element decorative configurations.

10. The kit of claim 9 wherein said pastry dough is in multiple layered sheets.

11. The kit of claim 9 wherein said pastry dough is at least one rolled-up sheet.

12. The kit of claim 9 further including a set of pastry rolling units, each rolling unit including:
a first and second side;
each said pastry roller unit further adapted to be removably mounted on said rotary cutter;
whereby said pastry roller units may be mounted on said cylindrical rotary cutter such that rotary movement of said rotary cutter against a collection of dough cutting remnants will act to re-roll said remnants to sheet form for recycling.

13. A method of cutting decorative shapes from a sheet of pre-rolled, ready-to-bake pastry dough so as to produce shaped cookies, crackers and the like, said method including the steps of:
providing at least one pre-rolled sheet ready-to-bake pastry dough;
providing a substantially cylindrical rotary cutter having a central axis and mounted for rotation about said axis;
providing at least one pastry cutter unit with a first and second side, and adapting said pastry cutter unit to be removably mounted on said rotary cutter;
providing a cutter blade element with a decorative configuration to be imparted to said dough during cutting so as to produce said decorative shapes;
fixedly mounting said cutter blade element to said first side of said at least one pastry cutter unit so that said cutter blade element extends outwardly from said first side;
forming at least one connecting element on said second side of said pastry cutter unit;
forming at least one complementary connecting element within said cylindrical rotary cutter;
adapting said complementary connecting element to cooperate with said pastry cutter unit connecting element to fasten said cutter unit on said rotary cutter;
selecting at least one specific pastry cutter unit having a cutter blade element with a particular decorative configuration;
mounting said at least one pastry cutter unit on said cylindrical rotary cutter through cooperation of said cutter unit connecting element and said complementary connecting element;
moving said rotary cutter such that it rotates against said sheet of dough and pressing said cutter blade element thus cutting shapes from said dough;
whereby rotary movement of said rotary cutter against said sheet of dough cuts shapes therefrom in patterns imparted by said cutter blade element decorative configuration.

14. The method of claim 13, further including the steps:
providing a plurality of pastry cutter units;
shaping a plurality of cutter blade elements into a series of unique decorative configurations;
affixing each of said plurality of cutter blade elements respectively to each of said plurality of pastry cutter units;
selecting a set of pastry cutter units from said plurality of pastry cutter units based on the unique decorative configurations of their cutter blade elements;
affixing said set of pastry cutter units to said rotary cutter;
moving said rotary cutter such that it rotates against said sheet of dough while pressing said set of pastry cutter units and cutting shapes from said pastry dough;
whereby plural shapes are cut from said sheet in patterns imparted by said cutter blade elements with unique decorative configurations.

15. The method of claim 13, further including:
providing said rotary cutter with at least one handle;
affixing said handle at the axis of said rotary cutter;
manipulating said rotary cutter by said handle so as to rotate said rotary cutter against said sheet of pastry dough.

16. The method of claim 14, wherein the step of affixing said set of pastry cutter units to said rotary cutter includes the further steps of:
forming complementary connecting elements on each of said pastry cutter units and said rotary cutter;
mutually engaging said complementary connecting elements so as to fasten said cutter units to said rotary cutter.

17. The method of claim 14, further including the step of:
forming said plural pastry cutter units such that they are generally identical to one another and mutually interchangeable on said cylindrical rotary cutter.

18. The method of claim 14, further including the step of:
collecting scrap dough remnants from the step of cutting shapes from said dough;
providing a set of substantially smooth pastry roller units;
mounting said smooth pastry roller units on said cylindrical rotary cutter;
moving said rotary cutter with said pastry roller units to press said roller units against said collected dough remnants thus forming a recycled dough sheet;
recycling said dough sheet for shape cutting.
